(19) United States
(12) Patent Application Publication
(10) Pub. No.: US 2009/0290826 A1
(43) Pub. Date: Nov. 26, 2009

(54) ROLLING ELEMENT BEARING WITH DIFFERENT GUIDE POCKETS

(75) Inventors: Alfred Pecher, Stadtlauringen (DE); Karl Bywalez, Schweinfurt (DE); Joachim Schleifenbaum, Niederwerrn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/302,138

(22) PCT Filed: May 22, 2007
(86) PCT No.: PCT/DE07/00924

§ 371 Date: Mar. 25, 2009

(30) Foreign Application Priority Data
May 24, 2006 (DE) 10 2006 024 376.5

(51) Int. Cl. F16C 33/44; F16C 33/38

(52) U.S. Cl. 384/527; 384/523

(57) ABSTRACT

The invention relates to a rolling element bearing comprising a cage with at least one first group of guide pockets in which rolling bodies are guided with a certain play. According to the invention, the degree of play is different at least in a first guide pocket of the first group from the degree of play in a second guide pocket of said first group of guide pockets.

### FIELD OF THE INVENTION

The invention relates to a rolling element bearing comprising a cage for guiding the rolling elements.

Rolling element bearings in certain operating states cause increased running noise which is disturbing in many applications. It has been assumed up until now that this generation of noise, which can be observed specifically at higher rotational speeds, occurs as a result of a chaotic cage movement, also referred to as cage instability.

DE 197 81 320 B4 discloses a reduced-noise rolling element bearing having a race which is designed as a composite hollow ring. The hollow ring is made up of a first ring part, which is in contact with the rolling elements, and a second ring part which encloses the first ring part. Between the ring parts is formed a gap which is filled with oil or another fluid. The raceway of the first ring part deviates in certain sections from the circular shape through one or more elastic raceway curvatures. At any time, some rolling elements are prestressed, with the result that the mounted shaft is likewise subject to radial prestressing. The shaft thus has only a slight possibility of self-movement, and therefore noise generation is reduced. The disadvantage with this solution is the high degree of effort which is required to set up the fluid-filled gap. The fluid must be under pressure, which means that corresponding measures for sealing are required. A further disadvantage is that the prestressing increases the rolling friction of the rolling elements on the races. Moreover, the noise resulting from the interaction between the cage and the rolling elements is only slightly damped.

As is known, for example, from EP 1 083 353 A2, noise reduction can also be achieved using special greases which exhibit a damping action. However, their low temperature resistance means that these greases cannot be used at higher bearing temperatures.

It is therefore the object of the present invention to provide rolling element bearings comprising a cage in which the operating noise is reduced by a measure which is simple to implement, without the rolling friction of the rolling elements being increased.

This object is achieved by a rolling element bearing according to the accompanying claim 1.

The invention is based on the recognition that rolling element bearings comprising a cage, which is made for example of sheet metal, brass or hard fabric and serves to guide the rolling elements, are subject to noise, in particular through an excitation of the cage, this noise resulting from a concerted movement of the rolling elements in conjunction with the cage. As a departure from the assumption held to date by those skilled in the art that a chaotic cage movement occurs during the occurrence of the above-mentioned cage instability, the present invention is based on the fact that the rolling elements in the cage of a conventional rolling element bearing are excited to produce an ordered movement. The rolling elements in a rolling element bearing, in conjunction with the cage, do not make a chaotic movement but rather a deterministic movement. When cage noise occurs, the rolling element bearing switches from a stable state of low-noise operation to a stable state of high-noise operation.

The stable state of the high-noise operation is characterized in that, during their movement in the pockets, the rolling elements periodically have a defined state which leads to the excitation of the cage. However, it is unimportant for this excitation that portions of the movement of the rolling elements can be unequal, irregular or chaotic. Designing the rolling elements and their pockets in the cage to be identical has the effect that at least the majority of the rolling elements periodically have an identical state during the movement in the pocket, that is to say perform a concerted movement. This state can be characterized by the location of the rolling element inside the pocket or else by the speed vector or the acceleration vector with respect to the pocket. This periodic state leads to a periodic excitation of the cage and finally to the vibration of the cage. The vibration of the cage is a main cause for the increased operating noise of the rolling element bearing. The vibration of the cage can be transmitted to further rolling element bearing and machine parts.

What is essential for the invention first of all is that the rolling elements are guided with a clearance in the guide pockets of the cage, which clearance differs at least in one of these pockets from the clearance in another pocket of the cage.

In this respect, the difference of the clearances in these guide pockets can be achieved not only through a different design of the respective guide pockets, in particular when the rolling elements are identical, but also through a different design of the respective rolling elements, in particular by designing the rolling elements to have different dimensions.

In a rolling element bearing according to the invention, the stable state of a high-noise operation can therefore not occur. Consequently, a periodic excitation of the cage by each of the rolling elements is not possible, and a concerted sequence of movements between the rolling elements and the cage cannot occur.

A particular advantage of this invention is that the noise generated in the region of the cage of a rolling element bearing is reduced as far as possible through a structural modification which is easy to implement. There is no need for any additional components or structural additions which would increase the outlay for the manufacture of a rolling element bearing according to the invention.

It is preferable that many rolling element bearings have exclusively identical rolling elements, i.e. identical within standard manufacturing tolerances. In other words, the rolling elements come within a certain grade (same nominal dimension). Some rolling element bearings have multiple groups of identical rolling elements which are guided in one or more cages. A periodic excitation of the cage of such a rolling element bearing can be avoided according to the invention in that the clearances within at least one of the groups of identical rolling elements are designed to be different.

Rolling element bearings according to the invention are particularly preferably ball bearings, in which case the rolling elements take the form of balls.

In a further preferred embodiment, the designs of the clearance in the individual pockets are such as to be largely irregular, with the result that in a plurality of the pockets no pocket of this group has the same clearance as another pocket of this group. Nevertheless, some of the pockets can have an identical design, in particular if the identically designed pockets are not arranged next to one another or opposite one another. Preferably, no pocket is exactly identical to another pocket.

In a modified embodiment, the clearance in the pockets of a group for guiding identical rolling elements differs in terms of different shapes of the pockets. For example, the pockets can have an elliptical cross section, with these ellipses not being geometrically similar but having an identical or similar circumference. The different shape of the pockets can also be achieved through specific shape configurations, such as local widenings or indentations. In the case of cages in which the rolling elements are guided at one or more guiding edges, the edges can have a different design. For example, in box-type pockets in which the rolling elements are guided at four edges, the edge spacings of the pockets can vary.

In a particular embodiment, the clearance in the pockets of a group for guiding identical rolling elements does not differ in terms of a different shape of the pockets. All of the pockets of a group for guiding identical rolling elements are geometrically similar and differ only in terms of a scaling factor.

Pockets for guiding rolling elements can usually be characterized by a radius which describes the size of the volume in which the rolling elements can rotate. This volume is defined by the geometry of the cage.

In the case of ball bearings, the pockets usually have a spherical design. The variability of the clearance in the pockets can be described in such cases by radii of different size.

Examples of other pocket shapes which are also included here are a box shape or a frame shape. In an advantageous embodiment of a rolling element bearing according to the invention, the radii of the pockets therefore have a different size; in particular, in the case of a ball bearing according to the invention having balls, the radii of the spherical pockets have a different size.

In a modified embodiment, the clearance in the pockets of a group for guiding the rolling elements does not differ in terms of a different shape of the pockets, but in terms of a different design of the respective rolling elements. In other words, use is made here of different rolling elements, or rather rolling elements of different dimensions, which differ or whose dimensions differ over and above the standard manufacturing tolerance.

Further advantages, details and developments of the invention will become apparent from the following description of a number of embodiments, with reference to the drawing.

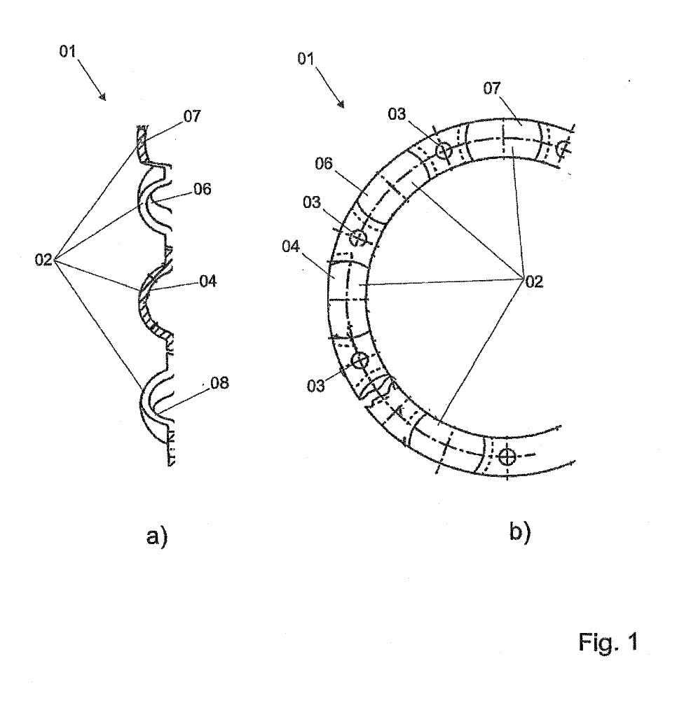

FIG. 1, which is the only FIGURE, shows two views of a cage 01 of a rolling element bearing according to the invention. Illustration a) of FIG. 1 shows a lateral sectional view of a portion, with four pockets, of a cage half of the cage 01. Illustration b) of FIG. 1 shows a plan view of a portion, with four pockets, of the cage half of the cage 01.

The half of the cage 01 that is shown in FIG. 1 serves for guiding eight balls (not shown) which function as rolling elements in a ball bearing (not shown). For this purpose, the cage 01 has eight spherical pockets 02. Between the pockets 02 are arranged holes 03 for feeding through rivets or other connection means (not shown). For assembly of the ball bearing, the eight balls are arranged between the two halves of the cage, and the two halves of the cage 01 are connected to one another using eight rivets. In the embodiment shown, the cage 01 has an outside diameter of about 70 mm and an inside diameter of 65 mm and is made of a sheet metal having a thickness of 1 to 2 mm.

The eight pockets 02 are distributed uniformly over the annular cage 01. Consequently, the center points of the pockets 02 are each at an angle of 45 degrees to one another. The balls have a diameter tailored to the pocket size. The spherical pockets 02 are designed to be slightly larger than the balls such that the balls are guided with a clearance in the pockets 02. The clearance allows the balls to roll freely in the cage 01. Furthermore, a lubricant is present in the gaps between the balls and the pockets 02 such that the balls can roll with low friction in the pockets 02.

The radii of the eight spherical pockets 02 are designed to differ in size. This is not a different size which is conditioned by manufacturing tolerances since given today's precision manufacturing such tolerances would be too small to prevent a regular excitation of the cage. In the embodiment shown, the radii of the pockets 02 are in the following ratios to one another:
first pocket 04: R1=8.45 mm
second pocket 06: R2=R1+1.4 mm
third pocket 07: R3=R1−0.41 mm
fourth pocket (not shown): R4=R1
fifth pocket (not shown): R5=R2
sixth pocket (not shown): R6=R3
seventh pocket (not shown): R7=R2+0.5 mm
eighth pocket 08: R8=R1+0.35 mm.

The pockets 02 in this example have an average radius of 8.979 millimeters. The radii of the pockets 02 are up to 1.37 millimeters larger and up to 0.94 millimeters smaller than the average radius of the pockets 02. These deviations amount to a multiple of the standard manufacturing tolerance.

The radii of the pockets 02 are selected at random from a predetermined range. They are preferably up to 20 percent larger or smaller than the average radius of the pockets 02.

In the above-mentioned example, the dimensions for the clearance in the pockets 02 range from 0.29 millimeter to 2.6 millimeters and therefore differ from one another approximately by a factor of 10. This relative indication is a guide value for implementing the clearance in the pockets 02 of a rolling element bearing according to the invention. The difference of the dimensions for the clearance in the pockets is limited by the minimum admissible dimension for the clearance and the maximum admissible dimension for the clearance. The minimum admissible clearance is given when an even smaller clearance would result in a considerable increase in the rolling friction and in consequent heating. The maximum admissible clearance is given when an even larger clearance would not allow the balls to be guided reliably. In a rolling element bearing according to the invention, it is not absolutely necessary to use these limits to dimension the clearance. The rolling element bearing according to the invention can be designed in such a way that the dimensions for the clearance are considerably larger than the minimum admissible clearance and considerably smaller than the maximum admissible clearance. The relationship between the smallest and the largest dimension for the clearance can amount, for example, from a two-fold to a hundred-fold difference. This relationship must be made to suit the rolling element bearing and its operating parameters.

The above list of examples for the radii of the pockets 02 reveals that the third pocket 07 and the sixth pocket 02, the first pocket 04 and the fourth pocket 02, and the second pocket 06 and the fifth pocket, each have the same size. The pockets 02 each having the same size should not be arranged next to one another nor opposite one another. A majority of five of the eight pockets 02, which is formed for example by the first, second, third, seventh and eighth pockets 02, does not have any pocket 02 in which the clearance is designed to be exactly the same size as the clearance of another pocket 02 of this majority. The stated correspondences do not lead to a situation in which regular excitation of the cage 01, and hence increased noise generation, occurs. The number of correspondences and the range of values for the dimensions of the clearance must be chosen to suit the rolling element bearing and its operating performance. For example, it is possible in the case of a highly lubricated rolling element bearing having low speeds of rotation to select multiple correspondences and a small range of values for the dimensions of the clearance, since such a rolling element bearing is less inclined to switch to a state of high-noise operation. By contrast, the dimensions for the clearance in the pockets 02 of a rolling element bearing having very high speeds of rotation must be selected to be significantly more irregular and within a wider range of values.

### LIST OF REFERENCES

01 Cage
02 Pocket
03 Rivet hole
04 First pocket
05-
06 Second pocket
07 Third pocket
08 Eighth pocket

1. A rolling element bearing comprising a cage with at least a first group of guide pockets in which rolling elements are guided with clearance, characterized in that the clearance at least in a first guide pocket of the first group is designed to be different from the clearance in a second guide pocket of this first group of guide pockets.

2. The rolling element bearing as claimed in claim 1, wherein all the rolling elements belonging to a group of guide pockets are formed identically.

3. The rolling element bearing as claimed in claim 1, wherein for a majority of the guide pockets in the first group it is the case that none of the guide pockets in this majority has the same clearance as another guide pocket in this majority.

4. The rolling element bearing as claimed in claim 1, wherein all the guide pockets of the first group correspond in their shape and the different clearances result from varying dimensions.

5. The rolling element bearing as claimed in claim 4, wherein all the rolling elements are designed as balls and the guide pockets have a spherical shape, the clearance between the balls and cage being defined by a radius of the spherical shape.

6. The rolling element bearing as claimed in claim 5, wherein the radii of the spherical shape of the guide pockets have a value in the range between 0.8 times and 1.2 times an average radius dimension, the largest radius measuring at least 1.1 times the smallest radius.

7. The rolling element bearing as claimed in claim 1, wherein the cage comprises a plurality of groups of guide pockets.

8. The rolling element bearing as claimed in claim 1, wherein the cage is of one-part or multi-part design, in particular comprising two complementary cage halves which are connected at connection points between the individual guide pockets using connection means.

9. The rolling element bearing as claimed in claim 8, wherein the cage is made of sheet metal, plastic, brass or hard fabric.

10. The rolling element bearing as claimed in claim 1, wherein at least two rolling elements belonging to a group of guide pockets are of different design, in particular having different dimensions.

11. The rolling element bearing as claimed in claim 1, wherein the rolling element bearing is a ball bearing and the associated rolling elements take the form of balls.
